(19) United States
(12) Patent Application Publication
(10) Pub. No.: US 2025/0043737 A1
(43) Pub. Date: Feb. 6, 2025

(54) Heating Methods to Facilitate Engine In-Flight Restarts

(71) Applicant: Textron Innovations Inc., Providence, RI (US)

(72) Inventors: Thomas Dewey Parsons, Fort Worth, TX (US); Marc Ouellet, Sainte-Sophie (CA); Daniel Carrier, Laval (CA)

(73) Assignee: Textron Innovations Inc., Providence, RI (US)

(21) Appl. No.: 18/362,953

(22) Filed: Jul. 31, 2023

(51) Int. Cl. F02C 9/42; F02C 7/06; F02C 7/268

(52) U.S. Cl. CPC F02C 9/42; F02C 7/06; F02C 7/268; F05D 2220/329; F05D 2270/303

(57) ABSTRACT

Embodiments are directed to operating a multi-engine aircraft during a cruise flight condition. A first engine is put off-line during flight while allowing a second engine to continue operating. The second engine provides sufficient power to maintain the multi-engine aircraft in the cruise flight condition. An outside air temperature, a first engine temperature, and/or an engine oil temperature is monitored and, when the temperature is below a predetermined threshold, the engine oil for the off-line first engine is warmed. The off-line engine oil may be warmed by continuously or periodically cranking the first engine without restarting the first engine. Alternatively, the engine oil may be warmed using a heat exchanger, such as an air-to-oil or oil-to-oil heat exchanger, or by using electronic heaters on an oil tank.

### BACKGROUND

Rotorcraft drive systems can include various components that produce and transfer power. For example, engines and gearboxes are standard components. Such components generate heat and require lubrication. Proper lubrication serves to reduce heat generation and assist in heat removal from moving components within gearboxes. Under normal operating conditions, primary lubrication systems provide proper lubrication and heat removal.

### SUMMARY

A method of operating a multi-engine aircraft comprises, during a cruise flight condition, shutting down a first engine while allowing a second engine to continue operating. The second engine provides power required to maintain the multi-engine aircraft in cruise flight condition. The method further includes monitoring a temperature and, when the temperature is below a predetermined threshold, warming engine oil for the first engine without restarting the first engine. The engine oil is warmed by continuously or periodically cranking the first engine. The monitored temperature is an outside air temperature, a first engine temperature, or an engine oil temperature.

The engine oil may also or alternatively be warmed using a heat exchanger operable to transfer heat from a heat source to the engine oil, wherein the heat source is associated with the second engine. The engine oil may also or alternatively be heated using an oil tank shared between the first engine and the second engine or using electrical heaters on a first engine oil tank.

The description herein refers to first and second engines on an aircraft for simplification in various examples; however, it will be understood that the present invention applies to multi-engine aircraft having any number of engines.

Embodiments are directed to multi-engine aircraft, such as a twin-engine aircraft having a first engine and a second engine. Separate lubrication systems are configured to circulate engine oil to each of the first and second engines. An engine control unit (ECU) is operable to control the first engine. In order to conserve fuel during a cruise phase of flight, the first engine is put in an off-line mode while the second engine continues to operate. The first engine is cranked, without attempting to start the first engine, while in the off-line mode to allow circulation of the engine oil. Cranking of the off-line engine may be initiated, for example, by the ECU, by another aircraft system, or manually by a pilot via cockpit switches. The first engine may be cranked using a start-generator automatically operated. The first engine may be periodically or continuously cranked.

In some embodiments, the first engine may be continuously cranked by the ECU when a first engine oil temperature is below a threshold temperature.

The lubrication system further comprises an oil storage tank having electrical heater elements. The engine oil is heated in the oil storage tank when the ECU activates the electrical heater elements on the oil storage tank.

The aircraft further comprises a heat exchanger in the lubrication system. The heat exchanger is operable to transfer heat from a heat source to the engine oil. The heat source is bleed air from the second engine or from an additional engine, such as a third or fourth engine in a four-engine aircraft. Alternatively, the heat source may be oil from the second engine or another engine. The heat source may also be exhaust from an oil cooler, an electrical generator, or another air-cooled component on the second engine.

The lubrication system is configured to circulate engine oil to the first engine and to the second engine. Heated engine oil from the second engine can also be circulated through the first engine.

In another configuration, a multi-engine aircraft comprises a first engine, a second engine, and transmission system components associated with each engine. For example, each engine may be coupled to an output or angle gearbox stage that is further coupled to a main-rotor reduction gearbox. The engines may also be coupled to separate accessory gearboxes. The transmission system components, such as an output or angle gearbox stage, and the accessory gearboxes are driven directly by one of the engines and operate when only the associated engine is on-line. A gearbox lubrication system circulates a lubricant to the transmission system components and/or the accessory gearbox. The lubricant is separate from the engine oil in the first and second engines. The ECU or other aircraft system may control the gearbox lubrication system so that the lubricant is circulated to the transmission system components and/or the accessory gearbox while an associated engine is in an off-line mode. The lubricant may be a transmission oil that is circulated by an electrical pump in the lubrication system. The electrical pump may be controlled by the ECU, by another aircraft system, or by manual selection by aircrew.

The lubrication system may include a heat exchanger operable to transfer heat from a heat source to the lubricant. The heat source may be bleed air from the second engine or exhaust from an oil cooler, an electrical generator, or another air-cooled component on the second engine. The heat source may also be oil from the second engine.

### BRIEF DESCRIPTION OF THE DRAWINGS

Having thus described the invention in general terms, reference will now be made to the accompanying drawings, which are not necessarily drawn to scale, and wherein:

FIG. 1 shows a rotorcraft adapted for user with embodiments of the present application.

FIG. 2 illustrates a flight control system for a rotorcraft according to some embodiments.

FIG. 3 is a graph illustrating components of a total power required curve for an example rotorcraft.

FIG. 4 is a graph showing temperatures for an International Standard Atmosphere (ISA) static atmospheric model.

FIG. 5 is a graph showing typical temperature versus viscosity curves for turbine engine oils used to lubricate aircraft turbine engines and transmissions.

FIG. 6 is a block diagram illustrating components of a lubrication system for an engine of a multi-engine aircraft.

While the system of the present application is susceptible to various modifications and alternative forms, specific embodiments thereof have been shown by way of example in the drawings and are herein described in detail. It should be understood, however, that the description herein of specific embodiments is not intended to limit the system to the particular forms disclosed, but on the contrary, the intention is to cover all modifications, equivalents, and alternatives falling within the spirit and scope of the present application as defined by the appended claims.

### DETAILED DESCRIPTION

Illustrative embodiments of the system of the present application are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the device described herein may be oriented in any desired direction.

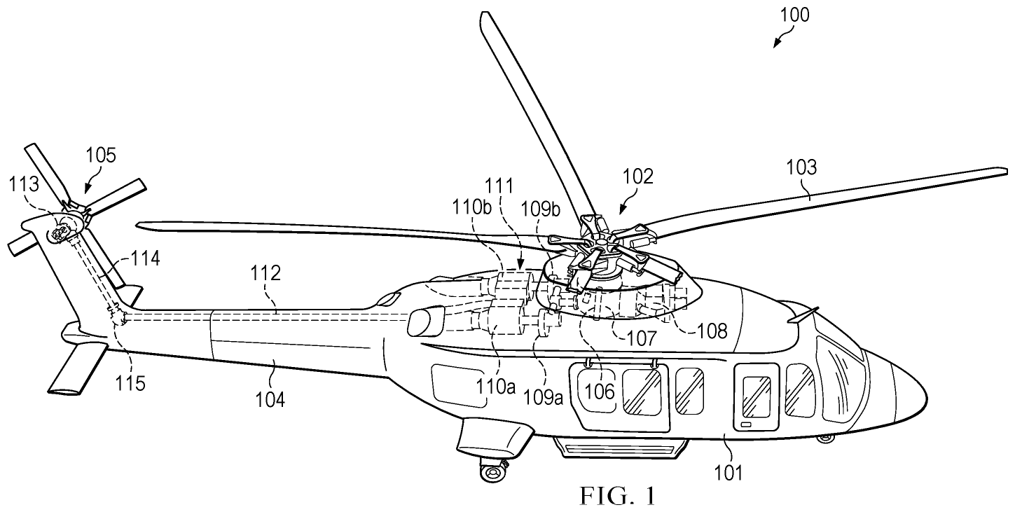

FIG. 1 shows a rotorcraft 100 in accordance with embodiments of the present application. In the exemplary embodiment, rotorcraft 100 is a helicopter having a fuselage 101 with an airframe and a rotor system 102 coupled to the airframe. A plurality of rotor blades 103 are operably associated with the rotor system 102 for creating flight. The pitch of each rotor blade 103 can be managed or adjusted to selectively control direction, thrust, and lift of the rotorcraft 100.

A tail structure 104 is depicted that further includes tail rotor and anti-torque system 105. Rotorcraft 100 further includes a rotor mast 106 that connects the main rotor 102 to a main rotor transmission gearbox 107. The main rotor gearbox 107 is connected to one or more accessory gearboxes 108 and one or more reduction gearboxes 109a, 109b. Each reduction gearbox 109a, 109b is connected to one or more engines 110a, 110b that are within an engine compartment 111. A tail rotor drive shaft 112 is connected to the main rotor gearbox 107 and transmits mechanical rotation to the tail rotor transmission gearbox 113 via tail rotor drive shaft 114 and intermediate gearbox 115.

It should be appreciated that rotorcraft 100 of FIG. 1 is merely illustrative of a variety of aircraft that can be used to implement embodiments of the present disclosure. Other aircraft implementations can include, for example, tiltrotors, fixed wing airplanes, hybrid aircraft, gyrocopters, a variety of helicopter configurations, and drones, among other examples. Moreover, it should be appreciated that even though rotorcraft 100 is a manned vehicle, embodiments described herein may also be used with unmanned, drone, or autonomous aircraft.

Engines 110a, 110b are the primary source of power for rotorcraft 100. Torque is supplied to the rotor system 102 and to the anti-torque system 105 using engines 110a and 110b. The performance envelope of rotorcraft 100 is defined by the relationship between the power required and the power available across various flight conditions. Power required is generally airframe dependent, while power available is essentially engine dependent. To create the lift force, the rotor system 102 and blades 103 must be turned and a mass of air accelerated generally in a downward direction. Power overcomes the drag of the rotors and creates lift. Changing conditions of air density, airspeed, and flight condition will all cause a change in power requirement.

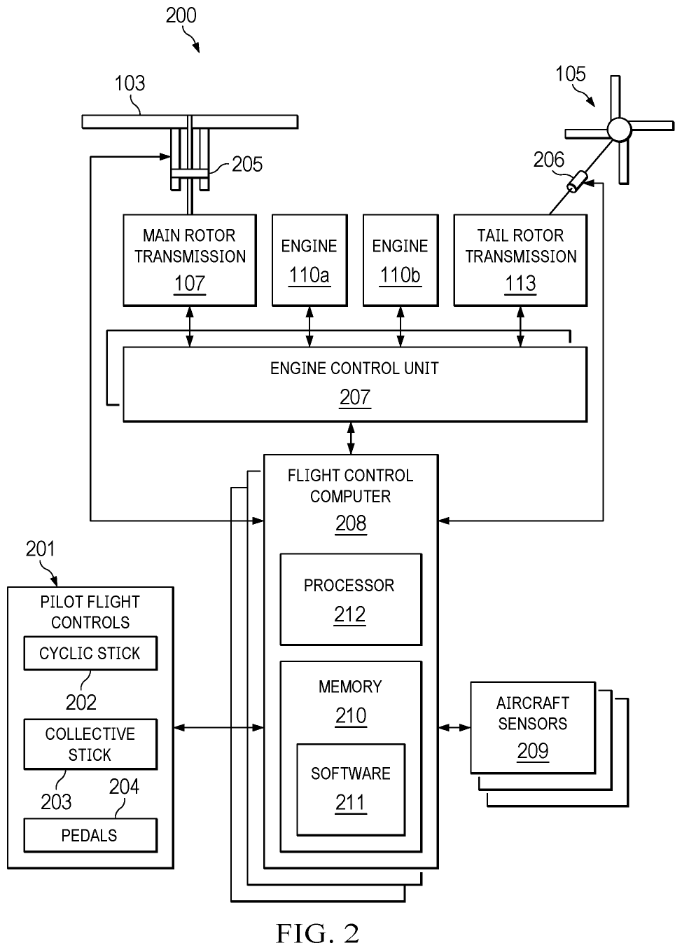

FIG. 2 illustrates a flight control system 200 for a rotorcraft 100 according to some embodiments. A pilot may manipulate one or more pilot flight controls 201 in order to control flight of the rotorcraft. The pilot flight controls 201 may include manual controls such as a cyclic stick 202, a collective stick 203, and pedals 204. Inputs provided by the pilot to the pilot flight controls 201 may be transmitted mechanically and/or electronically to flight control elements by the flight control system 201. Pilot flight controls 201 may represent any devices operable to change the flight characteristics of the rotorcraft.

Flight control elements or “effectors” on rotorcraft 100 may include mechanical and/or electrical systems operable to change the positions or angle of attack of the main rotor blades 103 and the blades on anti-torque system 105 or to change the thrust produced by engines 110a, 110b, for example. Flight control elements include systems such as the swashplate 205, tail rotor actuator 206, and systems operable to control the engines 110a, 110b. The flight control system 200 may adjust the flight control elements independently of the flight crew in order to stabilize the rotorcraft, reduce workload of the flight crew, and the like. The flight control system 201 includes an engine control unit (ECU) 207, which may also be an electronic engine control (EEC) or an engine control computer (ECC), and flight control computer(s) (FCC) 208, which collectively adjust the flight control elements.

Various aircraft sensors 209 provide inputs to the FCC 208. Aircraft sensors 209 are in communication with the FCCs 208. The aircraft sensors 209 may include sensors for measuring a variety of rotorcraft systems, flight parameters, environmental conditions, and the like.

The flight control system 200 has one or more FCCs 208. In some embodiments, multiple FCCs 208 are provided for redundancy. One or more modules within the FCCs 208 may be partially or wholly embodied as software and/or hardware for performing any functionality described herein. For example, FCCs 208 may comprise a memory 210, including a non-transitory medium for storing software 211, and one or more processors 212 for executing instructions of software 211. Memory 210 in some embodiments is a memory system that includes both transitory memory such as RAM and non-transitory memory such as, ROM, EEPROM, Flash-EEPROM, magnetic media including disk drives, and optical media. Memory 210 stores software 211 as machine readable instructions executable by processor 212.

The ECCs 207 control the engines 110a, 110b. For example, the ECCs 207 may vary the output power of the engines 110a, 110b to control the rotational speed of the main rotor blades or the tail rotor blades. The ECCs 207 may control the output power of the engines 110a, 110b according to commands from the FCCs 208 or may do so based on feedback such a measured revolutions per minute (RPM) of the main rotor blades.

FCCs 208 and ECCs 207 control rotorcraft 100 through all phases of flight from takeoff to hover to climb out and cruise conditions and back to landing. ECCs 207 control the fuel flow to engines 110a, 110b. The power—and corresponding fuel flow—required by engines 110a, 110b varies across different flight conditions depending on the airspeed and altitude of rotorcraft 100 among other factors. In some flight conditions, such as during takeoff, both engines 110a, 110b are required to operate at or near a maximum power output to provide sufficient torque to the main rotor transmission 107 and tail rotor transmission 113 to drive rotor system 102 and anti-torque system 105. In other flight conditions, such as during cruse flight at altitude, engines 110a, 110b can be operated at low power settings that use a much lower fuel flow.

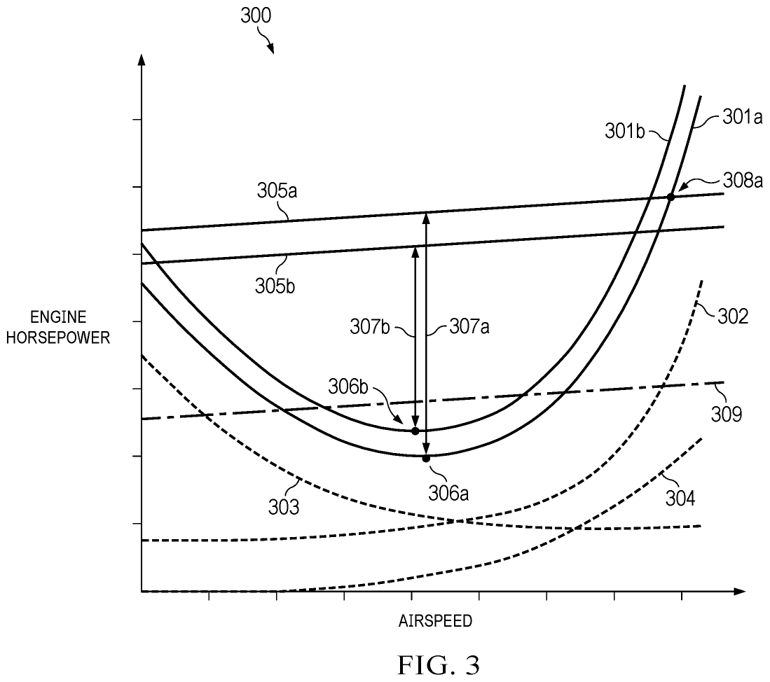

FIG. 3 is a graph 300 illustrating components of a total power required curve for an example rotorcraft. Curve 301a represents total power required at sea level, and curve 301b represents total power required at altitude. The required power 301a can be broken down into component parts related to rotorcraft profile drag, induced drag, and parasitic drag. Profile power drag curve 302 generally represents the power required to overcome the friction drag on the blades and to move the rotor through the air. Induced power drag curve 303 generally represents the power required to overcome the drag created by rotor thrust. As angle of attack increases, the airflow moving down through the rotor causes the total lift vector to tilt rearwards thereby creating induced drag. Parasitic drag curve 304 generally represents the power required to move the airframe itself through the air. Summing these power components, as well as various miscellaneous power requirements, such as the tail rotor, hydraulic pumps, gearbox losses, generators, and the like, results in a total power required curve 301a that defines an example rotorcraft flight envelope at a sea level.

Although it is easier to move rotor blades and an airframe through thinner air at higher altitudes, the rotor blade pitch must be increased to create sufficient thrust at higher altitudes. This creates an overall increase in total power required as altitude increases. Accordingly, while curve 301a represents total power required at sea level, curve 301b represents the total power required as altitude increases (i.e., more power required as air density decreases with altitude increase).

Curve 305a represents power available from the rotorcraft engines at sea level. Curve 305b represents power available from the rotorcraft engines at altitude. As air density decreases with altitude increase, the power available decreases. The curves shown in FIG. 3 are understood to be highly simplified for a generic engine and rotorcraft to show typical variations due to changes in airspeed and altitude.

As illustrated in FIG. 3, airspeed has a significant effect on power required. Moving from a hover flight condition at a low airspeed into a forward flight condition at higher airspeeds results in a rapid decrease in required power 301a due to a change in the inflow angle of oncoming air over the rotor. This is caused by the decreasing induced power 303 as the rotor becomes more efficient with translational lift. Total power required 301a continues to decrease as airspeed increase until the power required reaches its minimum 306a. This is the point of greatest difference 307a between power required 301a and power available 305a. The difference 307a represents the excess power available from the rotorcraft engines for that flight configuration. Beyond the airspeed for minimum power required 306a, the rotor continues to become more efficient; however, air resistance increases the parasitic drag 304. As a result, total power required 301a then begins to rise until it meets power available at point 308a, which defines the maximum speed for the rotorcraft to maintain level flight. The power available is shown to increase with airspeed, it is understood that it could be the opposite for other rotorcraft applications.

While the discussion above refers to the available power curve 305a and required power curve 301a at sea level, the same general behavior occurs at a higher altitude as shown by available power curve 305b and required power curve 301b. At altitude, the minimum power required point 306b corresponds to an excess power available 307b. Typically, the excess power available at altitude 307b is smaller than the excess power available at sea level 307a. But under either flight condition, there is a large amount of excess power available from the rotorcraft engines.

As noted above, the rotorcraft 100 have a plurality of engines 110a, 110b. More than one engine allows for redundancy, such that a single engine outage may not result in total failure of the rotorcraft 100. In some embodiments, the engines 110a, 110b may operate in tandem under normal circumstances such that each engine 110a, 110b provides some power for the main rotor system 102. In the case of a multi-engine rotorcraft 101, the power available curves 301a, 301b represent power output of all engines 110a, 110b. Curve 309 represents the power available for a single engine 110a in one example. In some cases, the excess power available 307a, 307b may be greater than the power available 309 from a single engine alone in which case, the rotorcraft could operate using only a single engine in certain flight conditions.

To increase aircraft fuel efficiency during cruise flight, the rotorcraft may turn one engine OFF if the remaining engine provides sufficient available power for the aircraft configuration. Rather than have both engines burning fuel, if a single engine can support the rotorcraft's operations, then the fuel savings obtained by turning one engine OFF may provide additional flight time or range for the rotorcraft.

Engine restart time is one concern with turning an engine OFF while the rotorcraft is in-flight. Engine restart time can be significant, such as up to 60 seconds or more. The restart time is very critical under certain conditions, such as when the operating engine is failing or shuts down. Engine restart time is influenced by temperature among other factors. For example, cold temperatures increase engine oil viscosity, which in turn increases starting torque requirements. Cold temperatures make engine start more difficult, thereby increasing the engine start time. This problem can arise when a shutdown or off-line engine is exposed to high altitudes and/or cold temperatures during an extended cruise leg.

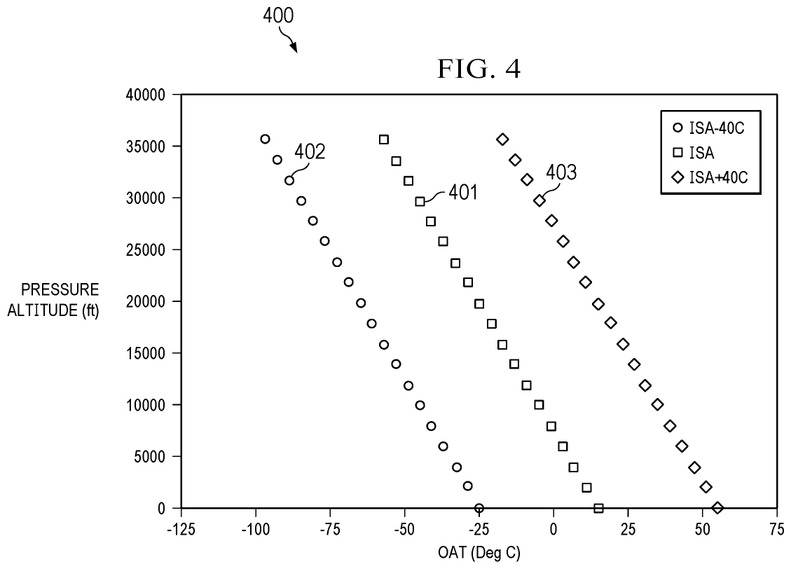

FIG. 4 is a graph 400 showing temperatures for an International Standard Atmosphere (ISA) static atmospheric model. The actual pressure and temperature of the atmosphere varies based on time and location. The ISA model provides a standard reference for atmospheric temperature. The standard atmosphere at sea level has a surface temperature of 15° C. (59° F.). The ISA model provides a standard temperature lapse rate wherein the temperature decreases at the rate of approximately 2° C. (3.6° F.) per thousand feet up to 36,000 feet, where the temperature is approximately −55° C. (−65° F.). Above this point, the temperature is considered to be constant up to 80,000 feet. Curve 401 illustrates a standard decrease in temperature as altitude increases starting with the ISA model standard surface temperature of 15° C. Curves 402 and 403 illustrate the standard decrease in temperature as altitude increases using the ISA model for surface temperatures that are ±40° C. compared to the ISA standard day. As illustrated, a 10,000 foot increase in altitude corresponds to a 20° C. (36° F.) decrease in air temperature. Prolonged operation at altitude can cold soak an engine and related systems, such as the lubrication systems.

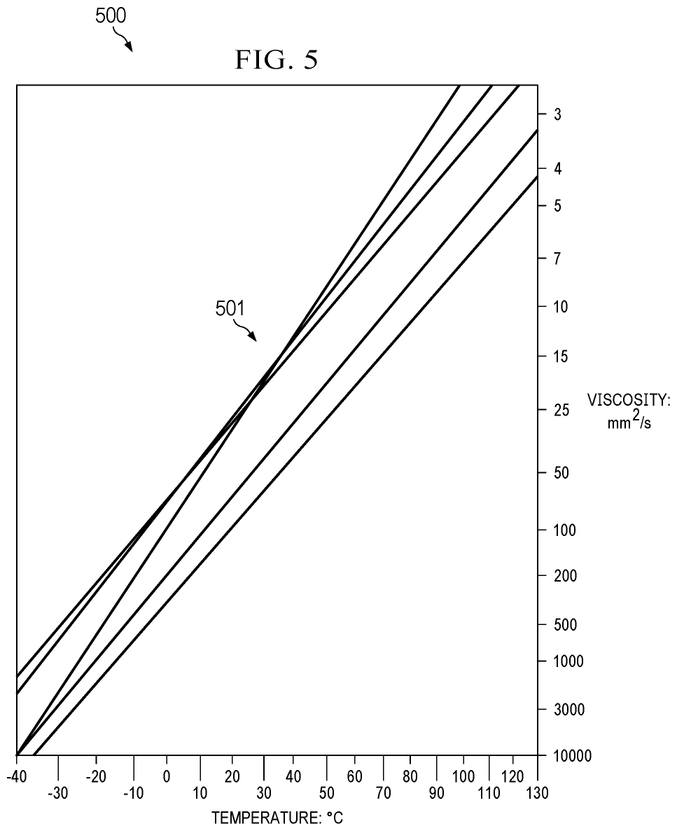

FIG. 5 is a graph 500 showing typical temperature versus viscosity curves 501 for various turbine engine oils used to lubricate aircraft turbine engines and transmissions. As illustrated, viscosity of the turbine oils increases as temperature decreases. When viscosity is high, the fluids become thicker, which results in a high resistance to flow. Moving these thicker fluids requires increased energy consumption due to increased friction and increased power input at the oil pump. This will cause an oil pump to have a slow or sluggish operation. Additionally, internal engine components, such as bearings, are harder to turn when the engine has been off-line and there is cold engine oil on the components. Since these components are coupled to the engines though an accessory gearbox, they will increase the torque required to turn an engine as the lubrication get cold.

To increase fuel efficiency during cruise flight, one engine of a multi-engine aircraft may be turned OFF during the cruise legs. A concern with turning an engine OFF while the aircraft is in-flight is that the time for engine restart can be significant, such as up to 60 seconds or more. The engine restart time is influenced by temperature. As noted above, cold temperatures at altitude increase the engine oil viscosity, which increases the starting torque requirements. This makes engine restart more difficult, thereby increasing the start time. This concern is exacerbated when the off-line engine is allowed to cold soak at high altitudes and cold temperatures during an extended cruise leg.

A multi-engine aircraft can take advantage of single-engine fuel efficiency during cruise flight and still maintain a safe engine-restart time by raising the engine oil temperature of the off-line engine. This rise in temperature will lower the oil viscosity and thereby reduce the engine start time. There are several methods for raising or maintaining the oil temperature for the off-line engine as discussed below.

In one arrangement, the off-line engine may be occasionally, periodically, or continuously cranked during cruise flight without attempting to start the engine (i.e., without introducing fuel into a cranked engine). The term “crank” as used herein refers rotating, turning, or windmilling an aircraft engine. Referring to FIG. 1, engines 110a, 110b may have a starter-generator that provides motorized torque to each engine for starting and that is utilized as a generator after the start has been accomplished. The starter-generator for an off-line engine may be driven by electrical power from the on-line engine. The starter-generator may be energized to crank the engine, which in turn will circulate engine oil. Friction created in the cranking engine and related lubrication systems will generate heat and warm the engine oil. When one engine is off-line during cruise flight, the starter-generator may be engaged by the ECC or the FCC at regular intervals or continuously.

The cranking of the off-line engine is not limited to the ECC or FCC. In other configurations, cranking of an off-line engine may be initiated and/or controlled when needed by another aircraft system or by cockpit switches that are activated by a pilot. The aircraft system or manual cockpit switches may cause activation of the starter generator, which in turn cranks the off-line engine. Aircraft systems such as any onboard avionics equipment or a dedicated oil-warming unit, such as a custom oil-warming controller, may be configured to initiate cranking of the off-line engine under selected flight and environmental conditions.

In other embodiments, the ECC or FCC monitors engine and/or oil temperatures and will engage the start-generator when engine or oil temperatures fall below a threshold level. Instead of using a starter-generator, in other aircraft configurations the engines may be turned using an auxiliary power unit (APU) which may be installed on larger helicopters or using cross-bleed air diverted from an operating engine to an air turbine starter on the off-line engine. The ECC or FCC controls the operation of the APU or cross-bleed start system and cranks the off-line engine on an occasional, periodic, or continuous schedule.

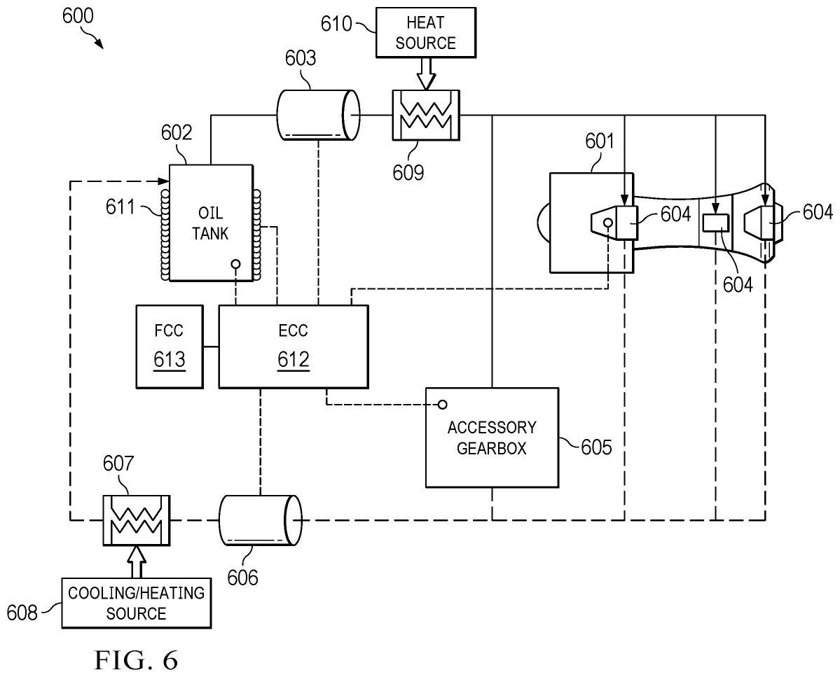

In another arrangement, an aircraft has a heated oil system, and the off-line engine is continuously or periodically turned with heated oil. FIG. 6 is a block diagram illustrating components of a lubrication system 600 for engine 601 of a multi-engine aircraft. An oil tank 602 holds oil for lubricating engine 601. A pressure pump 603 pumps oil from tank 603 through supply lines to lubricating units 604 in engine 601, which feed oil to engine bearings using nozzles or channels. Pressure pump 603 may also provide oil to an accessory gearbox 605 or other components. One or more scavenge pumps 606 collect used oil from the lubrication units 604 for return to oil tank 602. During normal engine operation (i.e., engine on-line), the used oil is heated by the engine bearings and is cooled in an oil cooler 607 before returning to oil tank 602. The oil cooler 607 may use fuel or air as a cooling source 608. For simplification of the illustration, other components, such as pressure reducing valves, filters, vent lines, and de-oilers, are not shown.

When engine 601 is turned OFF during cruise flight, the oil from tank 602 can be heated before circulated through engine 601. A heat exchanger 609 in the supply lines is used to heat the oil prior to distribution to lubrication units 604. The circulation of the heated oil will warm engine 601 when it is off-line and will reduce engine-restart times. The warm oil from heat exchanger 609 is pumped thru off-line engine 601 using continuous or periodic cranking. Heat exchanger 609 may use various heat sources 610. For example, heat exchanger 609 may be an air-to-oil or oil-to-oil heat exchanger.

Depending on engine and aircraft configuration, various sources of heat may be available to heat exchanger 609. For example, heat source 610 may be bleed air from an on-line engine (not shown). The bleed air is applied to a heat exchanger to warm oil for off-line engine 601. Alternatively, the heat source 610 may be oil from the on-line engine's oil tank. The on-line engine's oil is heated by operation of the on-line engine and is passed to heat exchanger 610 to warm the off-line engine oil. In such a configuration, heat exchanger 609 effectively functions as an oil cooler for the on-line engine. In another configuration, exhaust air from the on-line engine's oil cooler is used to warm heat exchanger 609. For example, the heated exhaust from oil cooler 607 could be used to warm another engine's oil. In other configurations, heat source 610 may be exhaust from electrical generators or other air-cooled components driven by the on-line engine.

The off-line oil system 600 may also be heated using electrical heater elements, such as electrical coils 611, that are embedded in or around oil tank 602. The heater elements 611 can be electrically turned on/off, which allows the off-line engine oil to be heated before it is circulated through engine 601.

In some arrangements, oil system 600 uses a shared oil tank 602 that is used by two or more aircraft engines. In this configuration, the oil in tank 602 would be heated by the on-line engine. When the off-line engine 601 is cranked, then the oil will already be warmed and heat exchanger 609 is either not needed or provides supplemental heating to the oil.

In another configuration, oil cooler 607 may be configured to function as an oil heater when engine 601 is off-line. Oil cooler 607 is a heat exchanger that is configured normally to cool engine oil for an operating engine. When engine 601 is off-line and does not heat the engine oil, then the cooling source 608 may be replaced with a heat source that causes heat exchanger 607 to warm the engine oil instead of cooling it. Heat exchanger 607 may use any of the engine-oil warming heat sources 610 available to heat exchanger 609.

A multi-engine aircraft may use or more of the oil heating techniques described herein in any combination. For example, heat exchanger 609 using any heat source 610, electrical heating elements 611, and a shared oil tank 602 are not mutually exclusive and can coexist in an oil system 600.

ECC 612 monitors and controls which off-line engine oil heating method is used. ECC 612 may be coupled to FCC 613 in some embodiments. In other embodiments, ECC 612 may be a function of FCC 613. ECC 612 may receive inputs from sensors, such as temperature sensors in engine 601, oil tank 602, lubrication systems 604, or accessory gearbox 605, that measure oil temperatures and/or equipment temperatures associated with engine 601. In one arrangement, ECC 612 monitors engine 601 temperatures when the engine is off-line and initiates oil-warming operations when the temperatures are below a predetermined threshold. For example, if the engine oil has dropped below a temperature associated with an undesirably high viscosity, then ECC 612 initiates engine-oil warming operations, such as causing pressure pump 603 and/or scavenge pump(s) 606 to operate and circulate the engine oil. Alternatively, ECC 612 may turn on or activate heating elements 611 as required to warm the engine oil above a desired threshold temperature.

In other embodiments, the ECC 611 may engage one or more of the heat exchangers 607 and 609. The ECC 611 may select the heat source 608, 610 used to warm the engine oil circulating in an off-line engine 601.

An aircraft may also be configured to allow a pilot to manually select when an engine is to be cranked in-flight without restarting and/or select when engine oil is to be circulated through a heat exchanger even though the engine is off-line. Such a selection may be made by cockpit switch or by interacting with the ECC or FCC.

In other configurations, instead of cranking the off-line engine to warm the engine oil, an electrical oil-circulation pump is used to motivate oil flow thru the off-line engine. For example, pressure pump 603 and/or scavenge pump(s) 606 and/or some other pump (not shown) may be used to circulate engine oil without turning engine 601. The oil that is circulating by pump action alone may also be heated using one or more of the heat sources noted above.

When engine 601 is off-line, electrical power required to run the oil-circulation pump(s) and/or to crank engine 601 can come from the on-line engine's permanent magnet alternator (PMA), starter-generator, or other electrical power source, such as a dedicated battery that gets continuously recharged by the on-line engine.

In other configurations, in-flight warming of lubrication systems may be extended to transmissions, such as one or more speed reduction gearboxes that are used for transmission of power from a gas turbine engine to a helicopter rotor. Each transmission has its own lubrication system that uses a transmission oil supply to lubricate and cool the transmission. The transmission oil supply is independent of and not shared with the engine oil supply. The transmission lubrication system has an internal pump for moving the oil supply. The transmission lubrication system has an oil cooler for cooling the oil supply, such as an air-oil cooler that uses ambient airflow to cool the transmission oil.

When an engine is turned OFF during cruise flight, a corresponding transmission may also stop moving when the input from the engine stops. This can result in the transmission oil getting cold over time, which will cause the same oil viscosity noted above for an engine (i.e., an increase in torque requirements). In addition to, or in the alternative to, turning an engine OFF during flight, a multiple-rotor aircraft may also stop one or more rotors from spinning during flight. Stopping a rotor from spinning will likely correspond to stopping a rotor transmission from operating. Such an in-flight stop for a transmission will cause transmission oil to get cold over time.

In the event that a transmission is temporarily stopped or disconnected during flight, such as due to an intentional engine shutdown or an intentional rotor stop, the engine-oil warming techniques noted herein may also be applied to the transmission oil system. For example, a transmission that is disconnected from a rotor system may be continuously or periodically cranked to force transmission oil circulation. This circulation will warm the transmission oil as it is passed across the gears and shafts turning in the gearbox.

The transmission oil system may also be heated using an air-to-oil or oil-to-oil heat exchanger. The source of heat to the heat exchanger may include engine bleed air, oil from an operating engine, exhaust from an electrical generator or from another air-cooled component. The transmission oil itself remains isolated from other lubrication systems, such as the engine oil system and other gearbox oil systems. The transmission oil may also be heated in a storage tank that has electrical heating elements. Like the engine oil-warming system, an ECC 612 or FCC 613 may determine when a transmission oil system should be warmed by turning the transmission and/or circulating transmission oil through a heat exchanger. Alternatively, an aircraft may be configured to allow a pilot to manually select a transmission to be cranked and/or to select when transmission oil should be circulated through a heat exchanger even though the transmission is disconnected from a rotor or propeller. Such a manual selection may be made by cockpit switch or by interacting with the ECC 612 or FCC 613.

The examples above refer to aircraft with first and second engines (or an on-line engine and an off-line engine). It will be understood that the invention applies to any multi-engine aircraft having any number of engines. The first and second engines (or the on-line engine and off-line engine) provide the minimum number of engines required to use the invention. In other embodiments, an aircraft having three or more engines may take advantage of the invention by shutting down any combination of one or more off-line engines and warming the engine oil for the off-line engines using accessories powered by any combination of one or more on-line engines.

An example aircraft comprises a first engine, a second engine, and a lubrication system configured to circulate engine oil to the first engine. A separate lubrication system is configured to circulate engine oil to the second engine. A starter-generator operates to crank the first engine. While in-flight, the first engine is cranked by the starter-generator while the first engine is in an off-line mode and the second engine is in an on-line mode. This allows circulation of the engine oil in the first engine without attempting to start the first engine. The start-generator can be controlled by an engine control unit (ECU), an aircraft system, a cockpit switch, or a flight control computer (FCC) to crank the first engine. The starter-generator may be either manually initiated by an aircrew or automatically operated by the ECU, aircraft system, or FCC. The first engine can be continuously or periodically cranked after a particular event, such as when a first engine oil temperature is below a threshold temperature or after a threshold time off-line.

The lubrication system for the first engine further comprises an oil storage tank having electrical heater elements that heat oil inside the storage tank and a temperature sensor configured to monitor an oil temperature within the storage tank. The engine oil is heated in the oil storage tank by the electrical heater elements when the ECU, aircraft system, or FCC activates the electrical heater elements on the oil storage tank based upon the oil temperature.

The aircraft may further comprise a heat exchanger in the first engine lubrication system. The heat exchanger operates to transfer heat from a heat source to the engine oil. The heat source may be bleed air from the second engine or from an additional engine. The heat source may be oil from the second engine or from an additional engine. The heat source may be exhaust from an oil cooler, an electrical generator, or another air-cooled component.

The first engine lubrication system can be configured to circulate engine oil to the first engine and to the second engine, and wherein heated engine oil from the second engine is also circulated through the first engine.

In another arrangement, an aircraft comprises a first engine having a first reduction gearbox configured to operate only when the first engine is on-line. A second engine has a second reduction gearbox configured to operate only when the second engine is on-line. A first lubrication system lubricates the first reduction gearbox, and a second lubrication system lubricates the second reduction gearbox. The first and second lubrication systems operate separately and independently. An aircraft system operates to control the lubrication systems. During flight, when the first engine is off-line and the second engine is on-line, the first oil from the first lubrication system is warmed by a heat source or by the second lubrication system without mixing with second oil from the second lubrication system.

The first oil can be circulated by an electrical pump. The electrical pump can be controlled by an engine control unit (ECU), an aircraft system, a cockpit switch, or a flight control computer (FCC) to circulate the first oil in the second reduction gearbox when the first engine is off-line.

The second lubrication system comprises a heat exchanger operable to transfer heat from a heat source to the first oil. The heat source may be bleed air from the second engine or exhaust from an oil cooler, an electrical generator, or another air-cooled component on the second engine. The heat source may be the second oil from the second engine or oil from an additional engine.

An example method of operating a multi-engine aircraft comprises, during a cruise flight condition, shutting down a first engine while allowing a second engine to continue operating. The second engine provides power required to maintain the multi-engine aircraft in the cruise flight condition. A temperature is monitored, and when the temperature is below a predetermined threshold, engine oil for the first engine is warmed without restarting the first engine using a warming procedure. The warming procedure may be automated and controlled by an aircraft system based on the temperature, may be initiated by a pilot based on monitoring the temperature in flight, or may be initiated by the pilot upon receiving an advisory message from the aircraft system indicating that warming oil for an off-line engine is required.

The engine oil can be warmed by continuously or periodically cranking the first engine. The engine oil can be warmed using a heat exchanger that operates to transfer heat from a heat source to the engine oil, wherein the heat source is associated with the second engine. The engine oil can be heated using an oil tank shared between the first engine and the second engine or using electrical heaters on a first engine oil tank. The monitored temperature may be, for example, an outside air temperature, a first engine temperature, an engine oil temperature, or any other temperature that indicates the viscosity of the engine oil.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

1. An aircraft, comprising:
a first engine;
a second engine;
a lubrication system configured to circulate engine oil to the first engine; and
a starter-generator operable to crank the first engine, wherein, while in-flight, the first engine is cranked by the starter-generator while the first engine is in an off-line mode and the second engine is in an on-line mode to allow circulation of the engine oil without attempting to start the first engine.

2. The aircraft of claim 1, wherein the start-generator is controlled by an engine control unit (ECU), an aircraft system, a cockpit switch, or a flight control computer (FCC) to crank the first engine.

3. The aircraft of claim 2 wherein the starter-generator is either manually initiated by an aircrew or automatically operated by the ECU, aircraft system, or FCC.

4. The aircraft of claim 1, wherein the first engine is continuously or periodically cranked when a first engine oil temperature is below a threshold temperature or after a threshold time off-line.

5. The aircraft of claim 1, wherein the lubrication system further comprises:
an oil storage tank having electrical heater elements that heat oil inside the storage tank;
a temperature sensor configured to monitor an oil temperature within the storage tank;
wherein the engine oil is heated in the oil storage tank by the electrical heater elements when the ECU, aircraft system, or FCC activates the electrical heater elements on the oil storage tank based upon the oil temperature.

6. The aircraft of claim 1, further comprising:
a heat exchanger in the lubrication system, the heat exchanger operable to transfer heat from a heat source to the engine oil.

7. The aircraft of claim 6, wherein the heat source is bleed air from the second engine or from an additional engine.

8. The aircraft of claim 6, wherein the heat source is oil from the second engine or from an additional engine.

9. The aircraft of claim 6, wherein the heat source is exhaust from an oil cooler, an electrical generator, or another air-cooled component.

10. The aircraft of claim 6, wherein the lubrication system is configured to circulate engine oil to the first engine and to the second engine, and wherein heated engine oil from the second engine is also circulated through the first engine.

11. An aircraft, comprising:
a first engine having a first reduction gearbox configured to operate only when the first engine is on-line;
a second engine having a second reduction gearbox configured to operate only when the second engine is on-line;
a first lubrication system for the first reduction gearbox;
a second lubrication system for the second reduction gearbox, wherein the first and second lubrication systems operate separately and independently;
an aircraft system operable to control the lubrication systems; and
wherein during flight, when the first engine is off-line and the second engine is on-line, then first oil from the first lubrication system is warmed by a heat source or by the second lubrication system without mixing with second oil from the second lubrication system.

12. The aircraft of claim 11, wherein the first oil is circulated by an electrical pump, and
wherein the electrical pump is controlled by an engine control unit (ECU), an aircraft system, a cockpit switch, or a flight control computer (FCC) to circulate the first oil in the second reduction gearbox when the first engine is off-line.

13. The aircraft of claim 11, wherein the second lubrication system comprises a heat exchanger operable to transfer heat from a heat source to the first oil.

14-15. (canceled)

16. A method of operating a multi-engine aircraft, comprising:
during a cruise flight condition, shutting down a first engine while allowing a second engine to continue operating, wherein the second engine provides power required to maintain the multi-engine aircraft in the cruise flight condition;
monitoring a temperature; and
when the temperature is below a predetermined threshold, warming engine oil for the first engine without restarting the first engine using a warming procedure that is automated and controlled by an aircraft system based on the temperature, that is initiated by a pilot based on monitoring the temperature in flight, or that is initiated by the pilot upon receiving an advisory message from the aircraft system indicating that warming oil for the first engine is required, wherein the engine oil is heated using a first engine oil tank shared between the first engine and the second engine.

17. The method of claim 16, wherein the engine oil is warmed by continuously or periodically cranking the first engine.

18. The method of claim 16, wherein the engine oil is warmed using a heat exchanger operable to transfer heat from a heat source to the engine oil, wherein the heat source is associated with the second engine.

19. The method of claim 16, wherein the engine oil is heated using electrical heaters on a second engine oil tank.

20. The method of claim 16, wherein the monitored temperature is an outside air temperature, a first engine temperature, or an engine oil temperature.

21. The method of claim 19, wherein the first engine oil tank is separate and distinct from the second engine oil tank.

22. The method of claim 19, wherein the first engine oil tank and the second engine oil tank are the same.
